(19) United States
(12) Patent Application Publication
(10) Pub. No.: US 2010/0095901 A1
(43) Pub. Date: Apr. 22, 2010

(54) Play toys and techniques for fabricating play toys

(76) Inventor: John Scott Cooper, Vista, CA (US)

Correspondence Address: BRUCE L. ADAMS, ESQ.;ADAMS & WILKS, SUITE 1231, 17 BATTERY PLACE, NEW YORK, NY, 10004, US

(21) Appl. No.: 12/653,534

(22) Filed: Dec. 15, 2009

Related U.S. Application Data
(63) Continuation-in-part of application No. 11/824,875, filed on Jul. 2, 2007.

(51) Int. Cl. A01K 29/00

(52) U.S. Cl. 119/707

(57) ABSTRACT

A play toy has strands of different materials braided together to form at least one braided body having a pre-selected cross-sectional shape and arranged in a pre-selected structural configuration.

### CROSS-REFERENCE TO RELATED APPLICATIONS

This application is a continuation-in-part of copending U.S. patent application Ser. No. 11/824,875, filed Jul. 2, 2007, which is herein incorporated by reference in its entirety.

### BACKGROUND OF THE INVENTION

1. Field of the Invention

The present invention relates generally to the field of toys and, more specifically, to play toys and techniques for fabricating play toys having braided bodies made of webbing materials, plush-like materials, rubber strips, or rubber tubing and of, combinations of these and other materials, as well as play toys having combinations of braided and non-braided bodies made of the foregoing materials and combination of such materials.

2. Background Information

It is desirable to provide pets and, in particular, dogs, with play toys that will entertain the pet and occupy the pet's attention for extended periods of time. Generally, play toys for dogs include chew, fetch, and tug types or combinations thereof. Since such toys are treated roughly and typically carried in the animal's mouth, it is important to provide a play toy that is safe and non-hazardous to play with, bite or chew. It is especially important that the toy does not break apart or disintegrate in the dog's mouth, thus potentially injuring the dog or causing it to gag or choke.

Presently, many play toys for dogs are constructed using conventional ropes, which may have a tendency for fraying, or include filler-containing members having sewn seams. The seams are typically the weakest points of the toys and, when broken by a dog, expose embedded filler materials to the dog's teeth. Both the fraying ropes and filler materials may be hazardous to dogs. For example, fraying portions of the ropes and filler materials accumulate dirt and bacteria, which become digested by the dogs.

It is also desirable to provide play toys for children that will provide entertainment for extended periods of time, are soft to the touch, are easily carried and manipulated by children, and are long-lasting, safe and non-hazardous to play with.

### SUMMARY OF THE INVENTION

Play toys and techniques for fabricating play toys having braided bodies made of webbing materials, plush-like materials, rubber strips, or rubber tubing and of combinations of these and other materials, as well as play toys having combinations of braided and non-braided bodies made of the foregoing materials and combination of such materials, are described herein.

In one aspect, the present invention provides a play toy comprising a plurality of strands of a material braided together to form at least one braided body having a pre-selected cross-sectional shape and arranged in a pre-selected structural configuration. In exemplary embodiments, the material for the strands is preferably a webbing, material, a plush-like material, rubber strips, or rubber tubing.

In another aspect, the present invention provides a play toy comprising a plurality of strands of different materials braided together to form at least one braided body having a pre-selected cross-sectional shape and arranged in a pre-selected structural configuration. In exemplary embodiments, the different materials for the strands are preferably combinations of webbing/plush materials, plush/rubber tubing materials, and plush/rope materials.

In yet another aspect, the present invention provides a play toy comprising a combination of braided and non-braided parts connected together to form a three-dimensional-shaped play toy, the braided part comprising a plurality of strands of one type of material or different types of materials braided together to form at least one braided body having a pre-selected cross-sectional shape and arranged in a pre-selected structural configuration. In exemplary embodiments, the materials for the strands are preferably webbing materials, plush-like materials, rubber strips, or rubber tubing, or combinations of these materials.

In the foregoing aspects, the play toys arranged in the pre-selected structural configuration may also include various play objects, such as tennis or rubber balls, pre-formed rubber or plastic figures, and the like.

In exemplary designs, the inventive techniques are used for fabricating chew, fetch, and tug types of pet toys or combinations thereof, as well as play toys suitable for use by small children and children with special needs. Various aspects and embodiments of the invention are described in further detail below.

The foregoing summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

The foregoing summary, as well as the following detailed description of the preferred embodiments of the invention, will be better understood when read in conjunction with the accompanying drawings. For the purpose of illustrating the invention, there is shown in the drawings embodiments which are presently preferred. It should be understood, however, that the invention is not limited to the precise arrangement and instrumentalities shown. In the drawings:

FIGS. 1A-1F are perspective views of a portion of a body fabricated using braided webbing materials during intermediate stages of manufacture of the body in one embodiment of the play toy according to the present invention;

FIGS. 2A-2B are perspective views of a portion of a body fabricated using braided webbing materials in finished (FIG. 2A) and intermediate (FIG. 2B) stages of manufacture in another embodiment of the play toy according to the present invention, and FIG. 2C is a cross-sectional view taken along the line 2C-2C in FIG. 2A;

FIGS. 3A-3B are perspective views of a body fabricated using braided webbing materials in finished (FIG. 3A) and intermediate (FIG. 3B) stages of manufacture in yet another embodiment of the play toy according to the present invention, and FIG. 3C is a cross-sectional view taken along the line 3C-3C in FIG. 2A;

FIGS. 4A-4B are perspective views of a body fabricated using braided webbing materials in finished (FIG. 4A) and intermediate (FIG. 4B) stages of manufacture in still another embodiment of the play toy according to the present invention, FIG. 4C is a cross-sectional view taken along the line 4C-4C in FIG. 4A, FIG. 4D is a cross-sectional view taken along the line 4D-4D in FIG. 4A, and FIG. 4E is an enlarged view of detail C in FIG. 4A;

FIGS. 5A-5B are perspective views of a body fabricated using braided webbing materials in finished (FIG. 5A) and intermediate (FIG. 5B) stages of manufacture in yet still another embodiment of the play toy according to the present invention, and FIG. 5C is a cross-sectional view taken along the line 5C-5C in FIG. 5A;

FIGS. 6-8 are perspective views of exemplary play toys, which are fabricated using braided webbing materials of the present invention;

FIGS. 9A-9B show another embodiment of a play toy according to the present invention, where FIG. 9A is a perspective view and FIG. 9B is a cross-sectional view taken along the line 9B-9B in FIG. 9A;

FIG. 10 is a side view of another play toy according to the present invention;

FIG. 11 is a front view of another play toy according to the present invention shown in an intermediate stage of manufacture;

FIG. 12 is a perspective view of another play toy according to the present invention shown in an intermediate stage of manufacture;

FIG. 13 is a front view of another play toy according to the present invention;

FIG. 14 is a front view of another play toy according to the present invention;

FIG. 15 is a front view of another play toy according to the present invention;

FIGS. 16A-16E are front views of a play toy according to another embodiment of the present invention, where FIG. 16A shows the play toy in a natural, unstretched configuration state and FIGS. 16B-16E show the play toy in various stretched configuration states; and

FIGS. 17A-17B are front views of a play toy according to another embodiment of the present invention, where FIG. 17A shows the play toy in a natural, unstretched configuration state and FIG. 17B shows the play toy in a stretched configuration state.

### DETAILED DESCRIPTION OF THE PREFERRED EMBODIMENTS

The images in the drawings are simplified for illustrative purposes and are not depicted to scale. To facilitate understanding, identical reference numerals have been used, where possible, to designate identical elements that are common to the figures, except that suffixes may be added, when appropriate, to differentiate such elements.

The appended drawings illustrate exemplary embodiments of the invention and, as such, should not be considered as limiting the scope of the invention that may admit to other equally effective embodiments. It is contemplated that features or steps of one embodiment may be beneficially incorporated in other embodiments without further recitation.

The term “exemplary” is used herein to mean “serving as an example, instance, or illustration.” Any embodiment or design described herein as “exemplary” or “alternative” is not necessarily to be construed as preferred or advantageous over other embodiments or designs.

Certain terminology is used in the following description for convenience only and is not intended to be limiting. The words right, left, front, top, rear, back, upper, lower, inner, outer, rearwardly, forwardly, clockwise, counterclockwise designate directions in the drawing to which reference is made. Such terminology includes the words above specifically mentioned and words of similar import.

In the following description of the preferred embodiments of the present invention, the term “about” is used to quantify the preferred dimensions and weights of the various components of the play toys. The term “about” is defined to cover the specific dimensions and weights described as well as values within a range of ±10% of the specific dimensions and weights described.

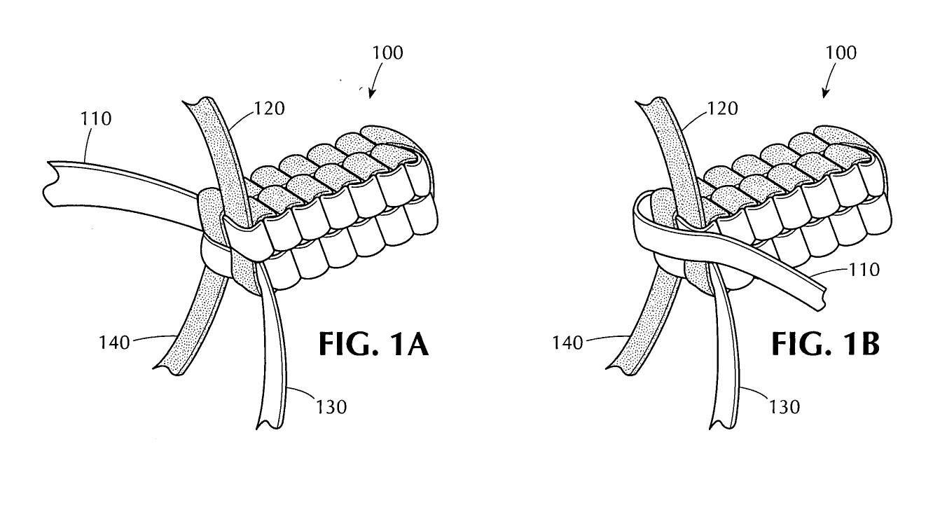

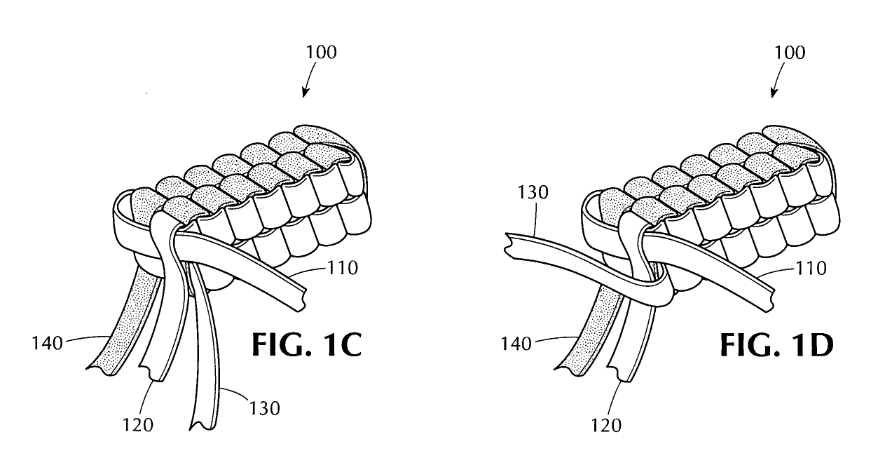

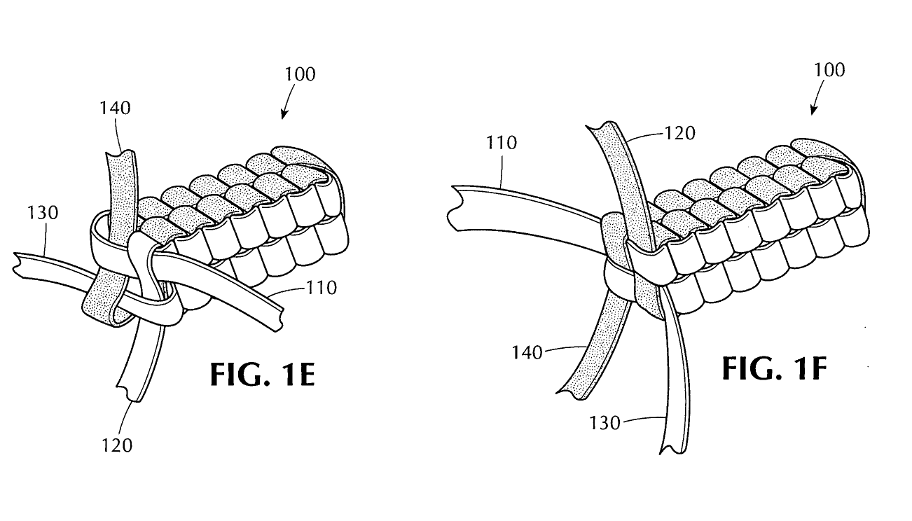

Referring to the figures, FIGS. 1A-1F depict perspective views of a portion of a body 100 fabricated using braided webbing materials during intermediate stages of its manufacture in accordance with one embodiment of the present invention. The body 100 is fabricated by braiding together four pieces or strands 110, 120, 130, and 140 of substantially flat nylon webbing. Preferably, the braided flat nylon webbing has a tensile strength of from about 1000 to about 10,000 pounds per square inch. These strands may be braided by hand or using a corresponding braiding machine. Hereafter, the term “strand” refers a machine-woven fabric produced from respective fibers or threads.

The nylon webbing is generally produced in a form of narrow bands (for example, about 1 to 10 mm width bands) of woven fabric and known for its strength, resilience to stress, and resistance to fraying. Nylon webbing is commercially available in rolls, e.g., rolls containing 50-500 meters of the respective strand. In popular applications, nylon webbing is commonly used in wide bands, such as found in car/plane seat belts and cargo straps. In the body 100, widths of the strands 110, 120, 130, and 140, as well as cross-sectional geometry of the body generally are selectively chosen to accommodate biting patterns of dogs of different size and age.

In alternative embodiments, a number of braided strands that form the body 100 may be either greater or smaller than four, as well as at least a portion of the strands may be fabricated from polypropylene, polyester or cotton webbing, canvas strapping, or a combination thereof. In further embodiments, one or more strands of the webbing material may have pre-selected color patterns or insignia. Coloring of the respective bands may be obtained by using pre-colored component threads or by a means of printing techniques.

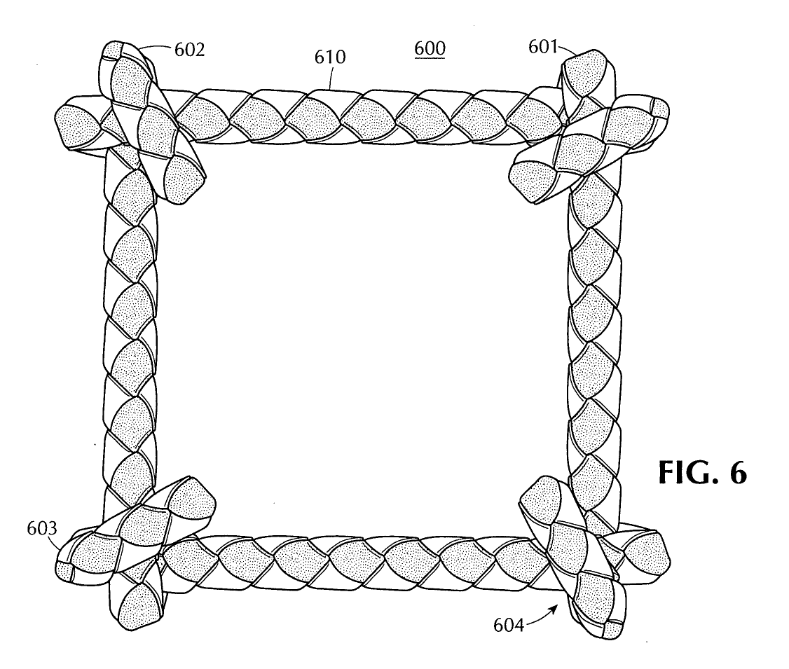

The body 100 may be braided to have a pre-selected cross-sectional shape (for example, generally square, rectangular, circular, triangular, or octagonal cross-sectional shape, and the like) and arranged in a pre-selected structural configuration, as discussed below in reference to FIGS. 6-8.

In the depicted embodiment, using the strands 110, 120, 130, and 140, the body 100 is fabricated in a sequence of steps schematically illustrated in FIGS. 1A-1F, which show consecutive positions of the strands, relative to one another, in a 6-step braiding cycle. Such cycle is repeated until a length of the body 100 attains a pre-determined value. The body 100 has a seamless structure having ends that may be furnished in a manner providing fray-free terminations. For example, loose ends of the strands 110, 120, 130, and 140 may be braided back into the body 100, braided together to form a ring-like structure, or melted, thereby forming an entirely seamless structural unit.

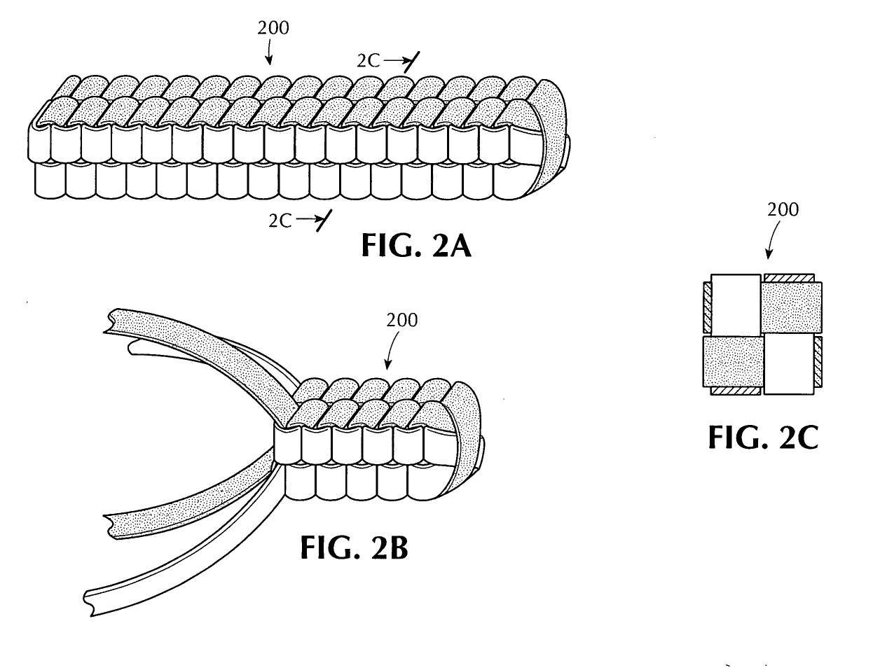

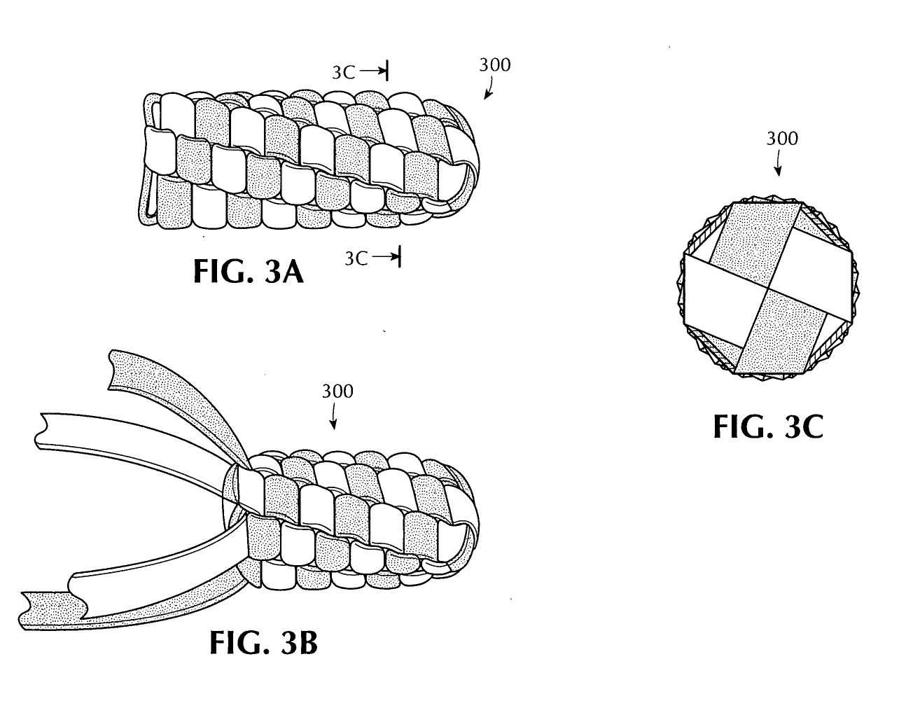

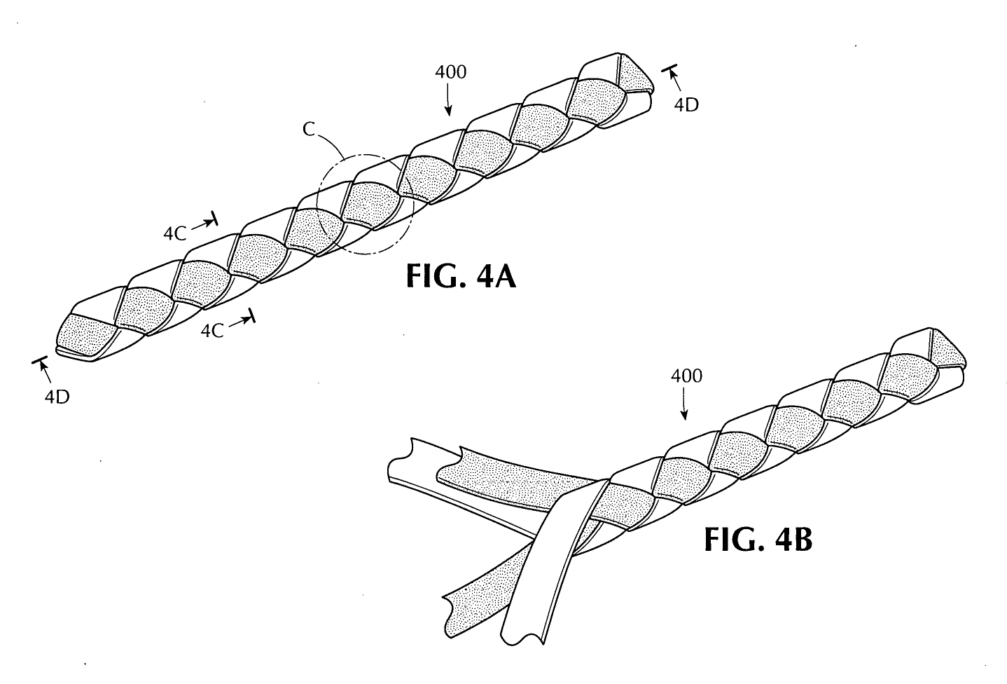

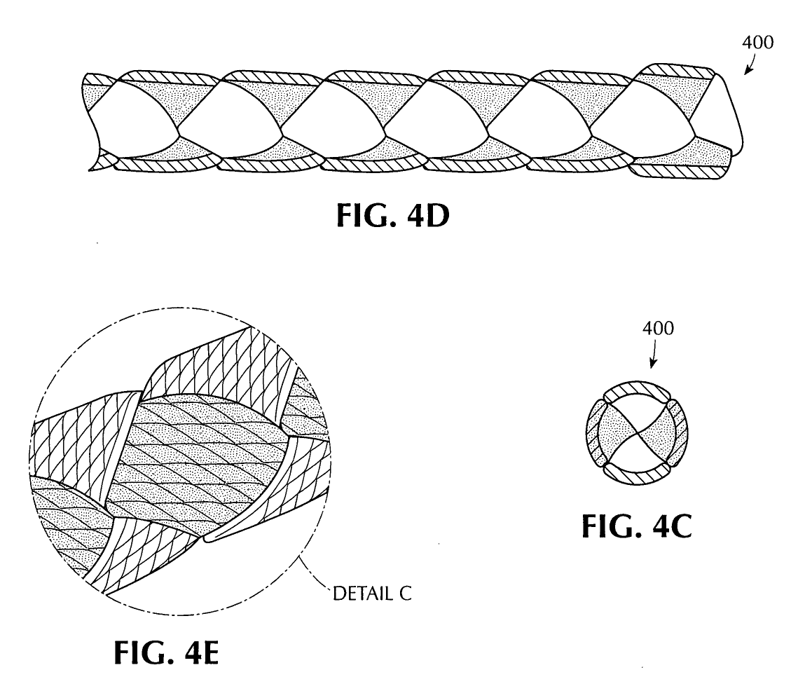

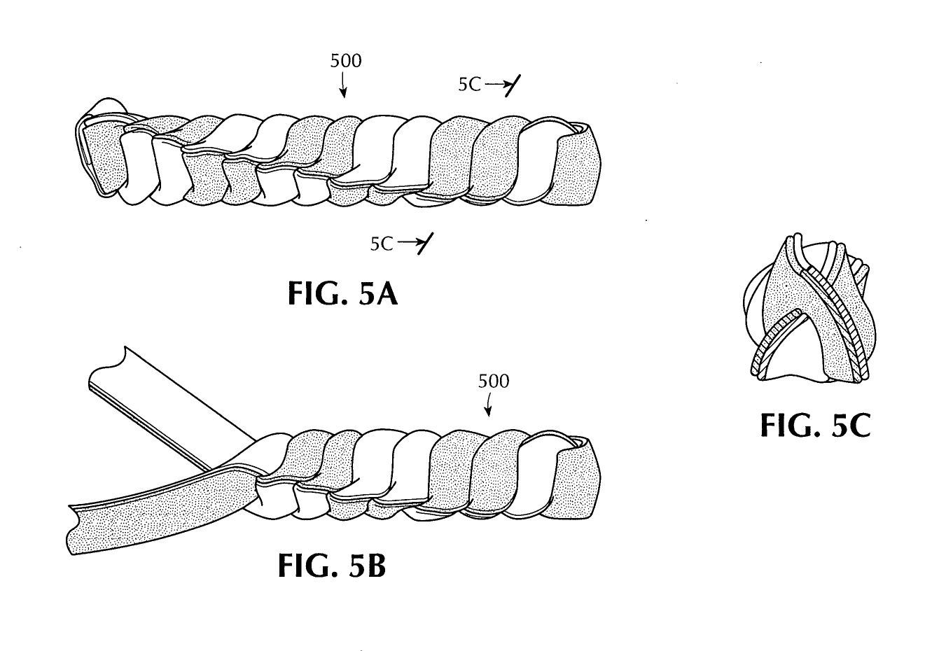

Exemplary alternative embodiment of the present invention are shown in FIGS. 2A-2C, 3A-3C, 4A-4E, and 5A-5C, which depict perspective views of bodies 200, 300, 400, and 500, respectively, which are shown in finished and intermediate stages of their manufacture. In particular, the bodies 200, 300, 400 are fabricated by braiding together four loose strands (e.g., see FIG. 4E corresponding to detail C in FIG. 4A), whereas in the body 500 the strands are paired together. Those skilled in the art will readily appreciate that, using the discussed above techniques, braided bodies may be fabricated in a near unlimited variety of cross-sectional shapes.

Referring to FIG. 6, a play toy 600 is fabricated using a single braided body 610, which is knotted near pre-selected points 601-603 of the body and has ends forming a knot 604. In the depicted embodiment, strands at ends of the body 610 are braided together to form a seamless ring-like body. In an alternative embodiment (not shown), strands at each end of the body 610 may be braided back into the respective end, thus forming a seamless rope-like body.

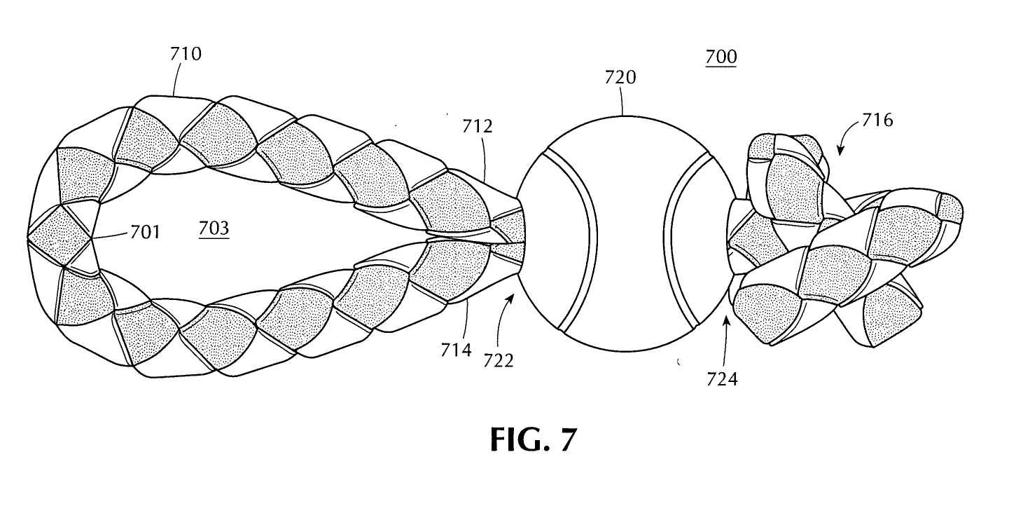

Referring to FIG. 7, a play toy 700 is fabricated using a single braided body 710 (illustratively, body 500) and a tennis ball 720 having opposing openings 722 and 724. The body 710 is folded near a pre-selected point 701 (for example, a middle point of the body 710) to form a loop 703, which extends from the opening 722. Ends 712, 714 of the body 710 movably propagate through the tennis ball 720 and form a knot 716 near the opening 724. Strands at the knotted ends of the body 710 may be braided together to form a seamless ring-like body (as shown) or be selectively braided back into the respective ends to form a seamless body-like body.

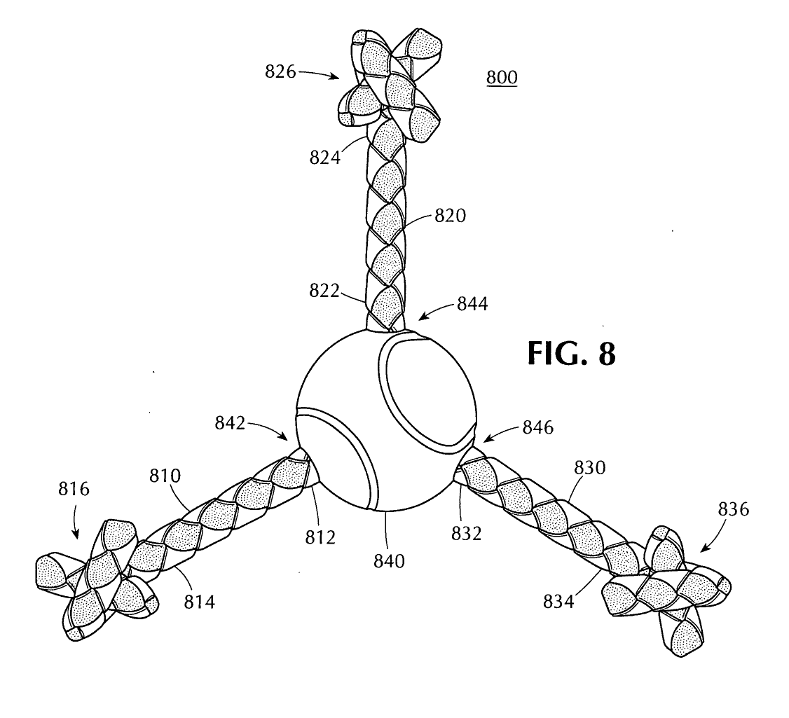

Referring to FIG. 8, a play toy 800 is fabricated using three braided bodies 810, 820, and 830 (illustratively, all of these bodies are the bodies 500) and a tennis ball 840 having openings 842, 844, and 846. First ends 812, 822, and 832 of the bodies 810, 820, and 830 are inserted into the tennis ball 840 through the openings 842, 844, and 846, respectively, and are captively retained or secured inside of the tennis ball such as by using an adhesive glue or other suitable bonding agent. Second ends 814, 824, and 834 of the bodies 810, 820, and 830 are terminated with knots 816, 826, and 836, respectively. In the depicted embodiment, strands at the knotted ends 814, 824, and 834 are selectively braided back into the respective ends, as discussed above in reference to FIGS. 6-7.

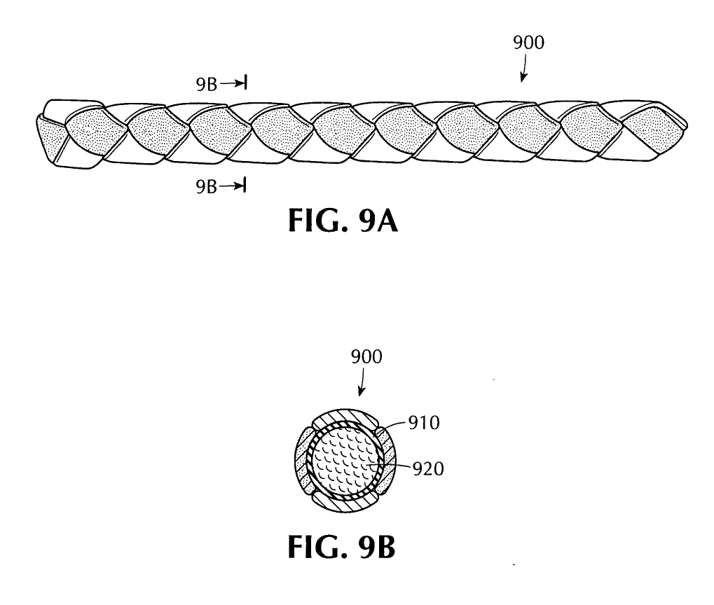

In an alternative embodiment shown in FIGS. 9A-9B, the strands may be braided over an insert 910, such as a substantially flexible plastic tubing or pre-molded structure, or otherwise encompass some inner space within the body 900. Such inner space may further be filled with filler materials 920, including cotton, synthetic fibers, and the like.

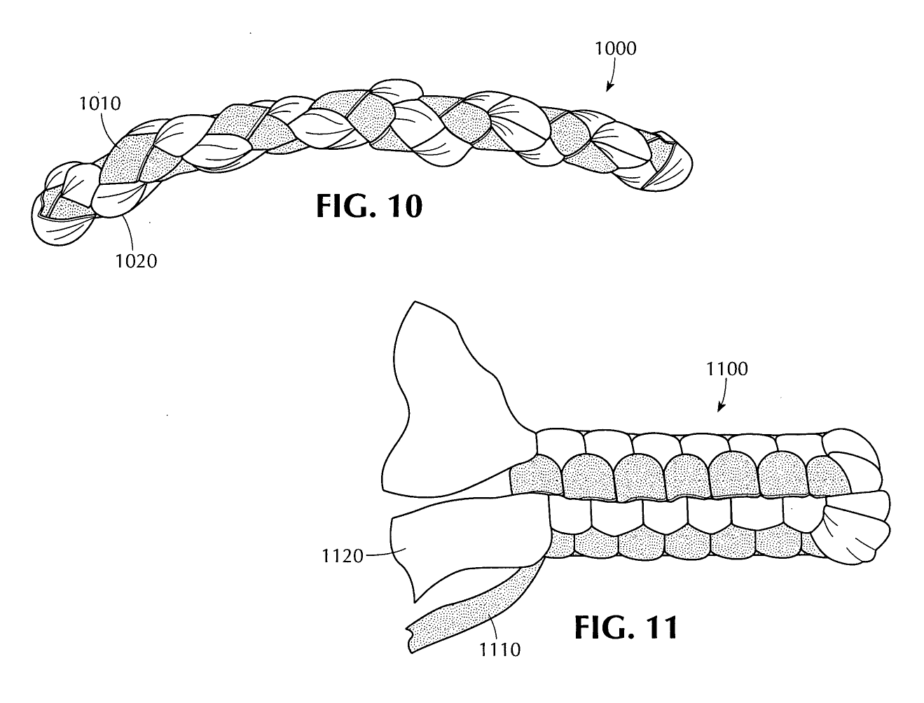

FIGS. 10-17 show alternative exemplary embodiments of play toys according to the present invention.

FIGS. 10 and 11 are side views of play toys in finished and intermediate stages, respectively, of their manufacture using a combination of braided webbing and plush materials. In FIG. 10, the play toy has a body 1000 made of multiple pieces or strands of webbing material 1010 and plush material 1020 braided together in a manner similar as described above with respect to FIGS. 4A-4E for the body 400 made of webbing material. In FIG. 11, the play toy has a body 1100 made of strands of webbing material 1110 and plush material 1120 braided together in a manner similar as described above with respect to FIGS. 1A-1F for the body 100 made of webbing material. In the play toys of FIGS. 10 and 11, the type of webbing material used is as described above for the embodiments of FIGS. 1A-9B.

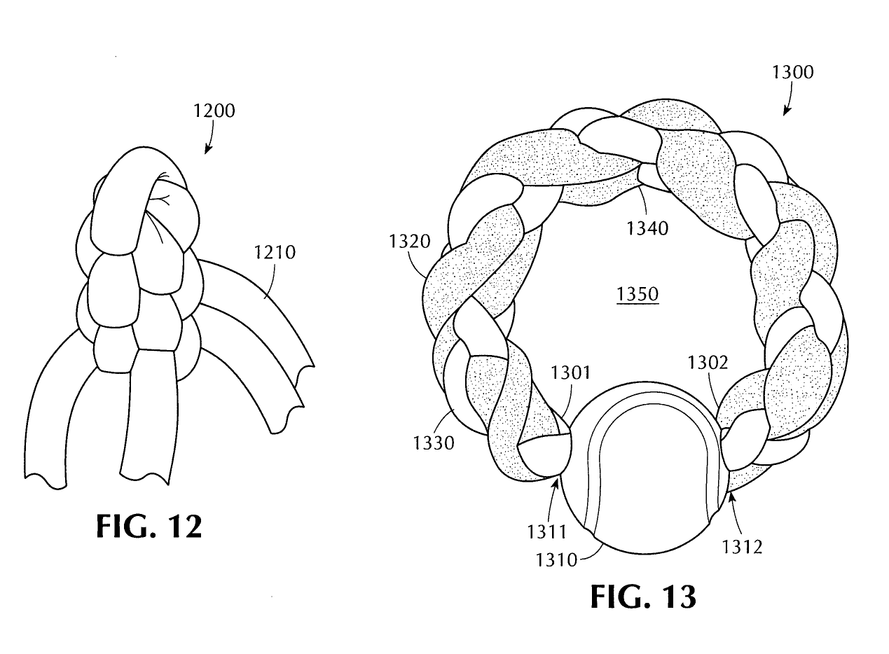

FIG. 12 is a perspective view of a play toy having a body 1200 shown in an intermediate stage of manufacture. The body 1200 is fabricated using only strands of rubber tubing 1210 which are braided together to form the body 1200. The manner of braiding the rubber tubing and the resulting configuration of the body 1200 is as described above in connection with the embodiment of FIGS. 4A-4B for the braiding of the body 400 using the webbing material.

FIG. 13 is a side view of a play toy including a braided body 1300 having opposite ends 1301, 1302 and a play toy in the form of a tennis ball 1310 having opposite openings 1311, 1312. The braided body 1300 is fabricated by braiding a combination of multiple strands of a plush material 1320 and rubber tubing 1330. The body 1300 is turned near a pre-selected point 1340 (for example, a middle point of the body 1300) to form a loop 1350, which extends from openings 1311, 1312 of the tennis ball 1310. The ends 1301, 1302 of the body 1300 are inserted into the tennis ball 1310 through the respective openings 1311, 1312 and are captively retained or secured inside of the tennis ball 1310 such as by using an adhesive glue or other suitable bonding agent.

Thus, as shown in FIG. 13, the combination of the braided body 1300 and tennis ball 1310 form a ring-like body. Although this embodiment illustrates the use of a tennis ball, other types of sport balls may be used, including a football, soccer ball, golf ball, hockey puck, etc. Alternatively, instead of a sports ball, other objects characterized as animal, human, fruit, rock formations, etc. may be used.

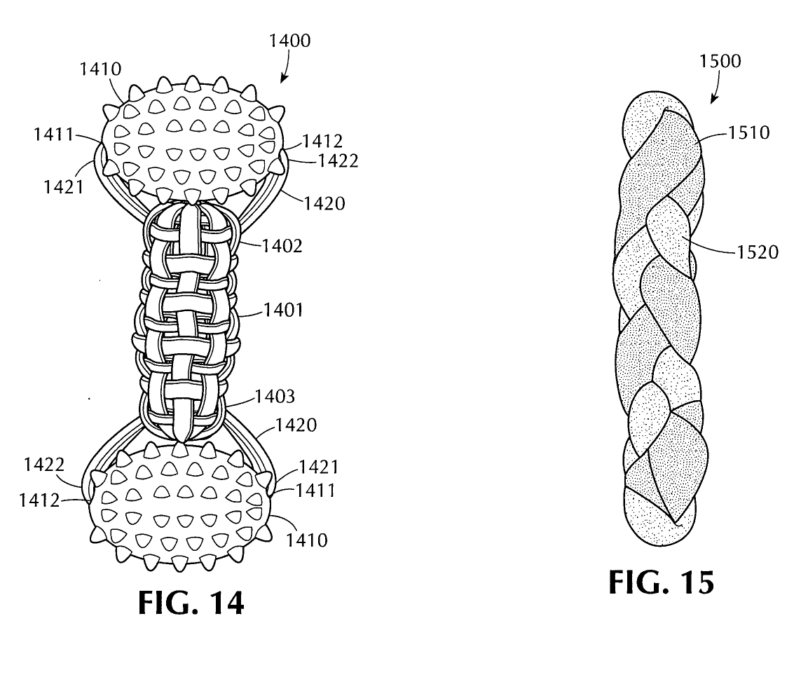

FIG. 14 is a side view of a play toy including a body 1400 made of braided strips of a rubber material 1401 having opposite ends 1402, 1403, and two play objects 1410 each having opposite openings 1411, 1412 movably attached to the respective opposite ends of the braided body 1400 via respective connecting strip members 1420 each having opposite ends 1421, 1422. The connecting strip members 1420 are looped through the braided strips of rubber material 1401 at the respective opposite ends 1402, 1403 of the body 1400, and the ends 1421, 1422 are inserted into the respective objects 1410 and are captively retained or secured inside of the objects 1410 so as to allow rotational movement of the objects 1410 relative to the connecting strip members 1420 and the body 1400. The strips of rubber material 1401 are substantially flat strips of rubber material. The objects 1410 are preferably made of a rubber material, such as the same type of rubber material used for the braided strips forming the body 1400, however, they are not limited to such type of object and to being made of such material. For example, the play objects 1410 may include one or more pre-formed figures made of a plastic or fabric material.

Furthermore, while the objects 1410 shown in FIG. 14 are generally oval-shaped, other types of shapes are suitable for the objects, including spherical-, cubic-, and cylindrical-shaped, so long as the objects 1410 are permitted to undergo rotation relative to the respective connecting strip members 1420 and the body 1400. Additionally, the outer surface of the objects 1410 may have some type of texture, such as bump-like elements protruding from the outer surface (as shown), or have a smooth surface.

FIG. 15 is a side view of a play toy with a body 1500 fabricated using a combination of braided pieces or strands of plush material 1510 and rope 1520. The configuration and fabrication method for the body 1500 is the same as described above in FIGS. 4A-4E for the body 400 made of webbing material. In this embodiment, the body 1510 is generally circular-shaped in cross-section, however, other cross-sectional shapes are suitable, such as the cross-sectional shapes described above with reference to the embodiments of FIGS. 1A-1F, 3A-3C, and 5A-5C. The rope is made from any suitable material, including natural and synthetic organic fibers.

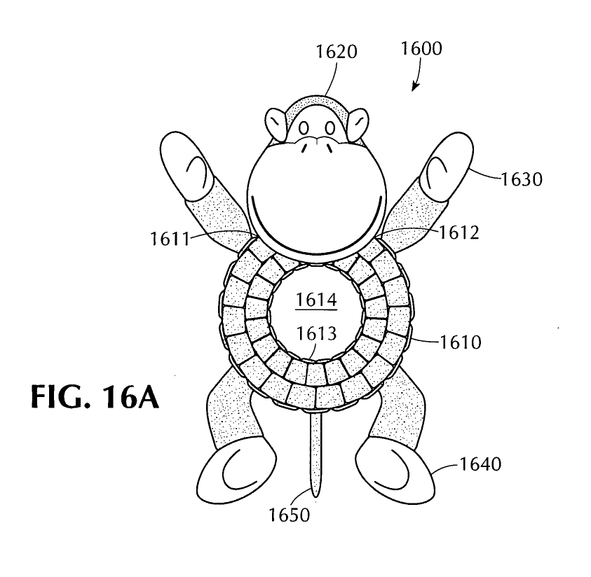

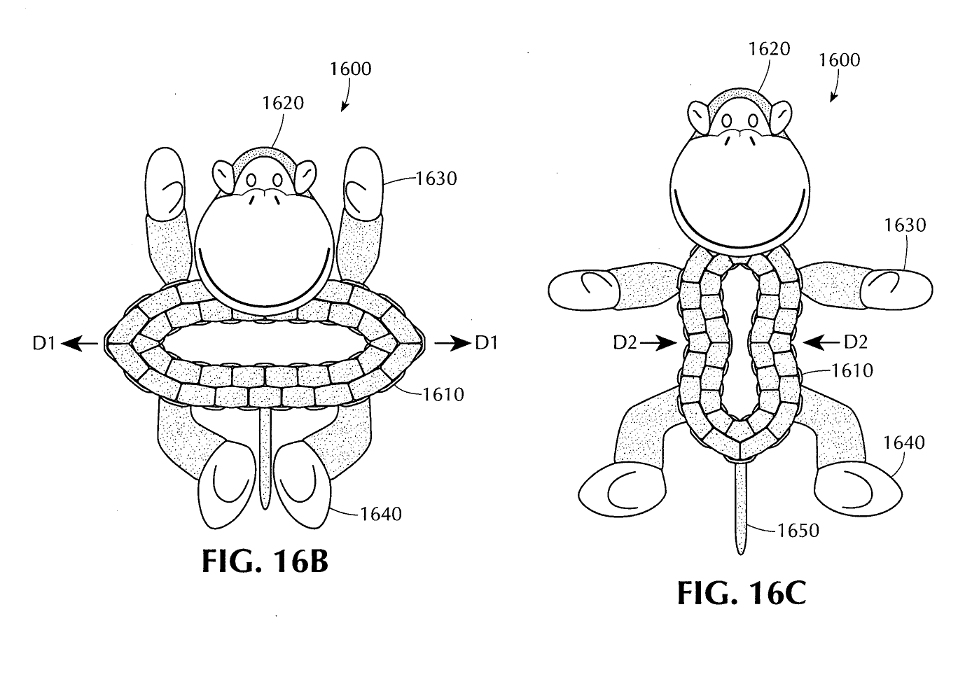

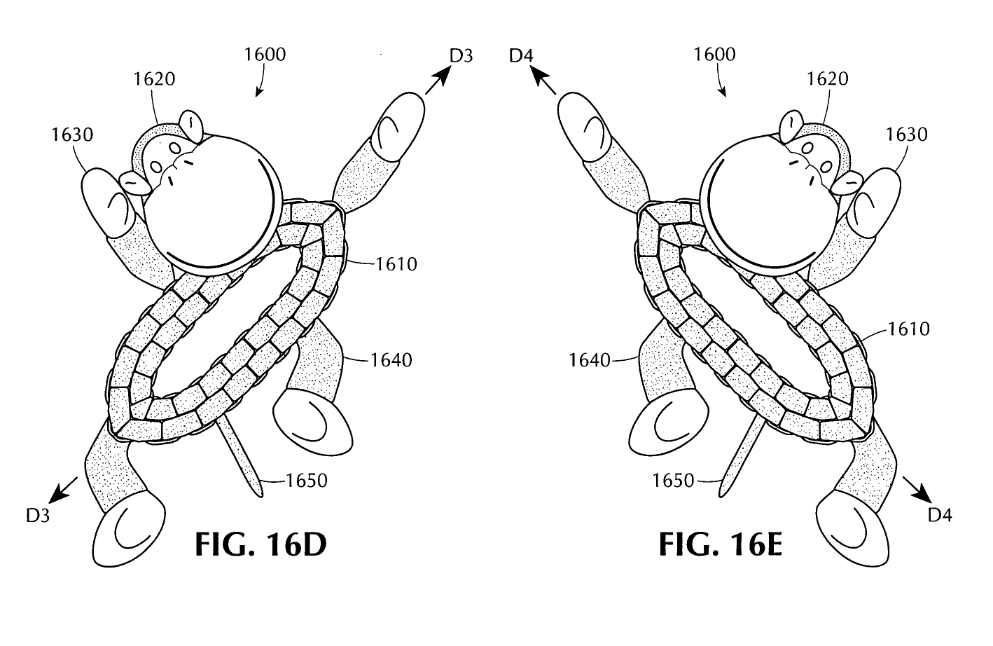

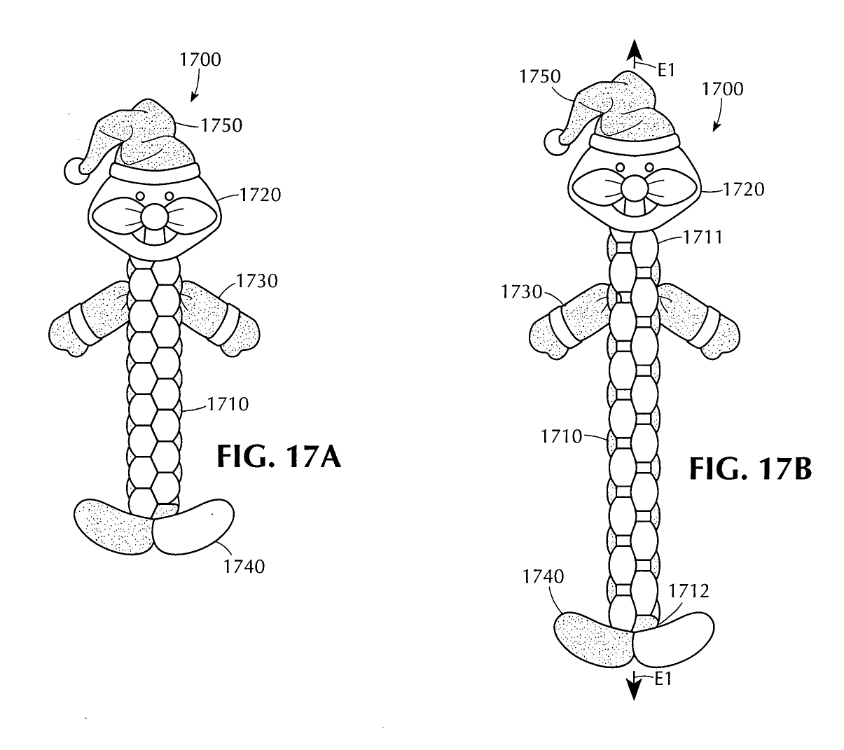

FIGS. 16A-16E and 17A-17B show other exemplary embodiments of play toys according to the present invention in which braided and non-braided parts are combined together to form the play toys.

In the exemplary embodiment shown in FIGS. 16A-16E, the play toy is a plush toy 1600 made of a plush fabric material and shaped three-dimensionally to form an animate figure. The plush toy 1600 includes a mid-section or center body 1610, a head 1620, two arm/hands 1630, feet/legs 1640 and a tail 1650. The head 1620 includes ear, eye, nose and mouth portions and is shaped to imitate the physical characteristics of the animate figure. The head 1620, arms/hands 1630, feet/legs 1640 and tail 1650 are the non-braided parts of the plush toy 1600 and, similar to other typical plush toys, are filled with cotton batting or other filler to give consistent thickness and softness to these parts.

The body 1610 is the braided part of the plush toy 1600 and is made entirely of braided pieces or strands of a plush fabric material formed generally in the same manner and configuration as described above in connection with the embodiment of FIG. 2A for the body 200 made of webbing material. The body 1610 has opposite end portions 1611, 1612 and is folded near a pre-selected point 1613 (for example, a middle point of the body 1610) to form a loop 1614. The non-braided portions are integrally attached to various parts of the body 1610, such as by stitching. More specifically, the head 1620 and the arm/hands 1630 are attached to the end portions 1611, 1612 of the body 1610; the tail 1650 is attached to a side surface portion of the body 1610 generally opposite to the pre-selected point 1613; and the feet/legs 1640 are attached to side surface portions of the body 1610 on opposite sides of the tail 1650 and between the tail 1650 and the corresponding arm/hand 1630. In the configuration shown in FIG. 16A, one of the arms/hands 1630 is disposed across one of the feet/legs 1640 and the other of ther arms/hands 1630 is disposed across the other of the feet/legs 1640.

FIGS. 16B-16E demonstrate various exemplary play modes of the plush toy 1600 that involve stretching or pulling the braided body 1610 in various directions denoted by arrows D1-D4 from a relaxed state of the plush toy 1600 shown in FIG. 16A.

In a first play mode shown in FIG. 16B, when the braided body 1610 is stretched (i.e., by pulling) in the directions denoted by arrows D1, the braided body 1610 assumes a generally oval configuration (i.e, from the generally circular configuration shown in FIG. 16A) that causes the arms/hands 1630 to move from the position shown in FIG. 16A to a position in which the arms/hands 1630 are generally parallel to one another, and that causes the feet/legs 1640 to converge towards one another from the position shown in FIG. 16A.

In a second play mode shown in FIG. 16C, when the braided body 1610 is pressed in the directions denoted by arrows D2, the braided body 1610 assumes a generally figure-8 configuration (i.e., from the generally circular configuration shown in FIG. 16A) that causes the arms/hands 1630 to move from the position shown in FIG. 16A to a position in which the arms/hands 1630 are generally aligned relative one another along a straight line, and that causes the feet/legs 1640 to move away or to diverge from one another from the position shown in FIG. 16A.

FIG. 16D shows a third play mode. When the braided body 1610 is stretched by pulling one of the arm/hand 1630 and the foot/leg 1640 disposed across one another in the directions D3, the braided body 1610 assumes a generally oval configuration that causes the other of the foot/leg 1640 (i.e., the unstretched leg) to move up and the head 1620 to tilt or move counterclockwise towards the other of the arm/hand 1630 (i.e., the unstretched arm/hand) from the configuration of the plush toy 1600 shown in FIG. 16A.

FIG. 16E shows a fourth play mode. When the braided body 1610 is stretched by pulling the other of the arm/hand 1630 and the foot/leg 1640 disposed across one another in the directions D4, the braided body 1610 assumes a generally oval configuration that causes the one of the foot/leg 1640 (i.e., the unstretched leg) to move up and the head 1620 to tilt or move clockwise towards the one of the arm/hand 1630 (i.e., the unstretched arm/hand) from the configuration of the plush toy 1600 shown in FIG. 16A.

While only four play modes have been described for the plush toy 1600, it is understood that other play modes are available without departing from the spirit and scope of the invention. For example, other play modes for the plush toy 1600 may include simultaneous pulling in opposite directions of the head 1620 and the tail 1650, the head 1620 and any one or both of the feet/legs 1640, and/or the tail 1650 and any one or both of arms/hands 1630.

In the exemplary embodiment shown in FIGS. 17A-17B, the play toy is a plush toy 1700 shaped three-dimensionally and made of a plush fabric material. The plush toy 1700 includes a center body 1710, a head 1720, two arm/hands 1730, feet/legs 1740 and a hat 1750. The head 1720 includes eye, nose, mustache, mouth, and tooth portions and is shaped to imitate the physical characteristics of an animate figure. The head 1720, arms/hands 1730, feet/legs 1740 and hat 1750 are the non-braided parts of the plush toy 1700 and, similar to other typical plush toys, are filled with cotton batting or other filler to give consistent thickness and softness to these parts.

The body 1710 is the braided part of the plush toy 1700 and has opposite end portions 1711, 1712 and is made entirely of pieces or strands of a plush fabric material formed generally in the same manner and configuration as described above in connection with the embodiment of FIG. 2A for the body 200 made of webbing material. The non-braided portions are integrally attached to various parts of the braided body 1710, such as by stitching. More specifically, the head 1720 and the feet/legs 1740 are attached to the end portions 1711, 1712, respectively, of the body 1710; the arms/hands 1730 are attached to opposite sides of the body 1710 at a position closer to the head 1720 than to the feet/legs 1740; and the hat 1750 is attached (e.g., also by stitching) to a top part of the head 1720.

FIG. 17B demonstrates an exemplary play mode of the plush toy 1700. In this play mode, when the braided body 1710 is stretched in the directions denoted by arrows El (i.e., by pulling from the feet/legs 1740 and hat 1750 in opposite directions) from the relaxed state shown in FIG. 17A, the braided body 1710 is elongated vertically to increase the overall size of the plush toy 1700 while the hands/arms 1730 remain generally in the same configuration as shown in the relaxed state of the plush toy 1700. Other play modes are available for the plush toy 1700 by stretching or pulling combinations of other parts of the braided and non-braided parts of the plush toy 1700 as described above for the plush toy 1600 in connection with FIGS. 16A-16E.

While the play toys described above are shaped to resemble animate figures, it is appreciated that other figures are available. In the foregoing embodiments of the play toys 1600 and 1700 shown in FIGS. 16A-16E and 17A-17B, various colors of the plush fabric and patterns may be applied to distinguish the features and body parts of a specific toy. It is also appreciated that the combination of strands of different materials (e.g., plush/webbing, plush/rope, and plush/rubber tubing) in a braid, particularly as described above with reference to FIGS. 10, 11, 13 and 15, imparts different textures on the same play toy for a patterned look.

It is appreciated that the various play modes and corresponding configurations of the plush toys 1600 and 1700 shown in FIGS. 16A-16E and 17A-17B are facilitated by the combination of the braided and non-braided parts forming the plush toys. In the exemplary embodiments, such configurations are particularly facilitated by forming the body 1610, 1710 of the respective plush toys 1600, 1700 of braided plush fabric material.

It is understood that the modification to the braided bodies described above with reference to FIGS. 9A-9B may be implemented in any of the foregoing embodiments described above with reference to FIGS. 10-17B. In this regard, the strands of the braided body may be braided over an insert, such as a substantially flexible plastic tubing or pre-molded structure, or otherwise encompass some inner space within the braided body. Such inner space may further be filled with filler materials, including cotton, synthetic fibers, and the like. Likewise, while the mid-section of the play toys shown in FIGS. 16A-17B employ only one braided body, it is understood that the mid-section may be formed of a plurality of braided bodies, such as the shown in the embodiment of FIG. 6.

In the foregoing embodiments, the plush material is preferably a hypoallergenic plush material that is soft to the touch, such as sheepskin, fleece, felt, cotton, velour, boa fabric, tricot fiber, polyester fiber, cotton/polyester blends, or a combination thereof. Both elastic and inelastic types of plush materials are suitable for the braided bodies described above. When an inelastic (i.e., non-stretch) plush material, such as acrylic or modified acrylic pile, is used, the various play modes described above which require stretching of the braided body can be accomplished due to the construction of the braided bodies which permit stretching between the braids formed by the pieces or strands of plush material.

The play toys described above are suitable for pets for playing fetch and pulling, such as a dogs. The plush toys, in particular, are very soft and well suited for puppies with new developing teeth, and add a different sensation in a pet's mouth from hard materials like rubber and stiffer nylon fabrics. Furthermore, plush materials also allow for the creation of figures and characters such as those described above with reference to FIGS. 16A-16E and 17A-17B. Additionally, plush materials allow for the placement of conventional “squeekers” within the various portions of the figures and characters, such as the head, hands/arms, feet/legs and braided body, to emit a squeaky sound when squeezed and thereby enhance the attractiveness of the play toy.

The play toys described above are also suitable for use by small children during play. As the braided bodies are generally thin and narrow, they can be easily grasped and manipulated by small hands of children and by children with special needs having immature grips. Particularly, the play toys constructed in the configurations shown in FIGS. 6, 7 and 16A-16E provide for a ring-like body (FIG. 6) or loop (FIGS. 7 and 16A-16E) that can be easily grasped to manipulate the play toys. The play toys according to the present invention, including the plush toys, can also be held by children with one hand, whereas a large plush doll, for example, would require two hands.

Those skilled in the art will readily appreciate that the braided bodies of the play toys of the present invention may also be used to fabricate other types of play toys for pets and children. For example, one or more braided bodies may be used to fabricate bone-shaped objects used as chew toys or disc-shaped flying objects used as fetch toys, as well as various objects, characters, and animate and inanimate figures for use by children during play. Such play toys may also be scaled to accommodate the pets and children of different age or size. In addition, the braided bodies may also be used in combination with components (e.g., balls or other pre-formed members) made using ballistic nylon, canvas, vinyl, polyvinyl chloride (PVC), and the like materials.

The previous description of the invention is provided to enable any person skilled in the art to make or use the invention. Various modifications to the invention will be readily apparent to those skilled in the art, and the generic principles defined herein may be applied to other variations without departing from the spirit or scope of the invention. Thus, the invention is not intended to be limited to the examples described herein but is to be accorded the widest scope consistent with the principles and novel features disclosed herein.

What is claimed is:

1. A play toy comprising: a plurality of strands of different materials braided together to form at least one braided body having a pre-selected cross-sectional shape and arranged in a pre-selected structural configuration.

2. A play toy according to claim 1; wherein the strands of different materials comprise a combination of strands of a webbing material and strands of a plush material.

3. A play toy according to claim 2; wherein the webbing material comprises nylon webbing, polypropylene webbing, polyester webbing, cotton webbing, canvas webbing, or a combination thereof; and wherein the plush material comprises sheepskin, fleece, felt, cotton, velour, boa fabric, tricot fiber, polyester fiber, cotton/polyester blends, or a combination thereof.

4. A play toy according to claim 1; wherein the strands of different materials comprise a combination of strands of a plush material and strands of a rubber tubing material.

5. A play toy according to claim 4; wherein the plush material comprises sheepskin, fleece, felt, cotton, velour, boa fabric, tricot fiber, polyester fiber, cotton/polyester blends, or a combination thereof.

6. A play toy according to claim 4; further comprising at least one play object coupled to the at least one braided body.

7. A play toy according to claim 6; wherein the play object comprises one or more tennis balls, rubber balls, pre-formed rubber or plastic figures, or a combination thereof.

8. A play toy according to claim 1; wherein the strands of different materials comprise a combination of strands of a plush material and strands of rope.

9. A play toy according to claim 8; wherein the plush material comprises sheepskin, fleece, felt, cotton, velour, boa fabric, tricot fiber, polyester fiber, cotton/polyester blends, or a combination thereof.

10. A play toy for animals according to claim 1;
wherein the strands of one of the materials comprises strands of substantially flat webbing material each having a width in a range from 1 to 10 mm.

11. A play toy according to claim 1; wherein the at least one braided body is provided with a filler material disposed in a space encompassed by the strands.

12. A play toy according to claim 11; wherein the filler material comprises a fiber filler, a plastic tubing, a pre-molded structure, or a combination thereof.

13. A play toy according to claim 1; wherein the strands of one of the materials comprises strands of flat nylon webbing.

14. A play toy comprising: a plurality of strands of a rubber material braided together to form at least one braided body having a pre-selected cross-sectional shape and arranged in a pre-selected structural configuration.

15. A play toy according to claim 14; wherein strands of the rubber material comprises strands of rubber tubbing material.

16. A play toy according to claim 14; wherein strands of the rubber material comprises substantially flat strips of rubber material.

17. A play toy according to claim 16; further comprising at least one a play object coupled to the at least one braided body.

18. A play toy according to claim 17; wherein the play object comprises one or more rubber balls, pre-formed rubber or plastic figures, or a combination thereof.

19. A play toy comprising: a combination of a braided part and a plurality of non-braided parts connected together to form a three-dimensional-shaped play toy, the braided part comprising a plurality of strands of one or more materials braided together to form at least one braided body having a pre-selected cross-sectional shape and arranged in a pre-selected structural configuration.

20. A play toy according to claim 19; wherein the plurality of strands of one or more materials comprises a plurality of strands of different materials.

21. A play toy according to claim 20; wherein the strands of different materials comprise a combination of strands of a webbing material and strands of a plush material.

22. A play toy according to claim 21; wherein the webbing material comprises flat nylon webbing.

23. A play toy according to claim 20; wherein the strands of different materials comprise a combination of strands of a plush material and strands of a rubber tubing material.

24. A play toy according to claim 19; wherein the plurality of strands are made only of a plush material.

25. A play toy according to claim 19; wherein the braided part forms a mid-section of the three-dimensional-shaped play toy.

26. A play toy according to claim 25; wherein the mid-section is looped.
